(19) United States
(12) Patent Application Publication
(10) Pub. No.: US 2025/0198913 A1
(43) Pub. Date: Jun. 19, 2025

(54) Optical Modulator, Laser Interferometer, And Spectroscopic Apparatus

(71) Applicant: SEIKO EPSON CORPORATION, Tokyo (JP)

(72) Inventor: Kohei YAMADA, Shiojiri (JP)

(21) Appl. No.: 18/985,858

(22) Filed: Dec. 18, 2024

(30) Foreign Application Priority Data
Dec. 19, 2023 (JP) 2023-213649

(51) Int. Cl. G01N 21/31

(52) U.S. Cl. CPC G01N 21/31; G01N 2201/0636

(57) ABSTRACT

An optical modulator coupled to a demodulation circuit for demodulating, from a laser light reception signal including a sample signal and a modulation signal, the sample signal based on a reference signal, the optical modulator including: a first resonator; a second resonator; an optical modulator configured to add, using the first resonator, the modulation signal to incident laser light; a first signal oscillator configured to generate, using the first resonator as source oscillation, a first signal having a first frequency; a second signal oscillator configured to generate, using the second resonator as source oscillation, a second signal having a second frequency; and a reference signal generator configured to generate the reference signal having a frequency lower than both the first frequency and the second frequency.

The present application is based on, and claims priority from JP Application Serial Number 2023-213649, filed Dec. 19, 2023, the disclosure of which is hereby incorporated by reference herein in its entirety.

### BACKGROUND

### 1. Technical Field

The present disclosure relates to an optical modulator, a laser interferometer, and a spectroscopic apparatus.

### 2. Related Art

JP-A-2020-165700 discloses a laser Doppler measurement apparatus for grasping a motion of a moving object. The laser Doppler measurement apparatus emits laser light to an object to be measured to measure a motion of the object to be measured based on Doppler-shifted scattered laser light. Specifically, a shift amount of a laser light frequency is obtained by an optical heterodyne interferometry method, and velocity and a displacement of the moving object are obtained based on the shift amount.

The laser Doppler measurement apparatus disclosed in JP-A-2020-165700 includes a frequency shifter type optical modulator. Such an optical modulator includes a quartz crystal AT resonator that performs thickness-shear vibration, and a diffraction grating having a plurality of grooves provided in parallel in a displacement direction of the resonator. The diffraction grating has a groove in a direction intersecting a vibration direction of the quartz crystal AT resonator. When laser light is emitted to the diffraction grating, the laser light is diffracted and a frequency of the laser light is shifted.

JP-A-2020-165700 is an example of the related art.

However, thickness-shear vibration has a high resonance frequency. Therefore, a frequency of a modulation signal superimposed on the laser light by the optical modulator disclosed in JP-A-2020-165700 is also high. Thus, in the laser Doppler measurement apparatus disclosed in JP-A-2020-165700, a circuit that performs computational processing on the modulation signal and a circuit that converts an analog signal into a digital signal need to be adapted to handle a high-frequency signal. As a result, cost of the circuits is increased.

Therefore, it is a problem to implement an optical modulator that can reduce a frequency of a signal to be subjected to computational processing in a demodulation circuit and can reduce cost of an electronic component and the like used in the demodulation circuit.

### SUMMARY

An optical modulator according to an application example of the disclosure is an optical modulator coupled to a demodulation circuit for demodulating, from a laser light reception signal including a sample signal added to laser light by a target object and a modulation signal added to the laser light, the sample signal based on a reference signal, the optical modulator including:
a first resonator configured to vibrate at a first frequency;
a second resonator configured to vibrate at a second frequency different from the first frequency;
an optical modulator configured to add, using the first resonator, the modulation signal to incident laser light;
a first signal oscillator configured to generate, using the first resonator as source oscillation, a first signal having the first frequency;
a second signal oscillator configured to generate, using the second resonator as source oscillation, a second signal having the second frequency; and
a reference signal generator configured to generate, using the first signal and the second signal, the reference signal having a frequency lower than both the first frequency and the second frequency.

A laser interferometer according to an application example of the disclosure includes:
a laser light source configured to emit laser light; the optical modulator according to the application example of the disclosure configured to add the modulation signal to the laser light;
a photodetector configured to detect a change in an intensity of the laser light including the sample signal and the modulation signal, and to output the laser light reception signal; and
the demodulation circuit coupled to the optical modulator and configured to demodulate the sample signal from the laser light reception signal based on the reference signal.

A spectroscopic apparatus according to an application example of the disclosure includes:
the laser interferometer according to the application example of the disclosure; and
a spectrometer including a spectroscopic optical system that includes a movable mirror and configured to generate spectroscopic spectral information derived from a sample, in which
the laser interferometer measures a displacement of the movable mirror, and
the spectrometer generates the spectroscopic spectral information based on a measurement result of the displacement of the movable mirror measured by the laser interferometer.

### BRIEF DESCRIPTION OF THE DRAWINGS

FIG. 1 is a functional block diagram showing a laser interferometer according to a first embodiment.

FIG. 2 is a schematic configuration diagram showing an optical modulator and an interferometric optical system shown in FIG. 1.

FIG. 3 is a block diagram showing an example of each circuit configuration of a reference signal generator and a demodulation circuit shown in FIG. 1.

FIG. 4 is a functional block diagram showing a laser interferometer according to a second embodiment.

FIG. 5 is a schematic configuration diagram showing an optical modulator and an interferometric optical system shown in FIG. 4.

FIG. 6 is a perspective view showing an optical modulator provided in the optical modulator according to the second embodiment.

FIG. 7 is a perspective view showing another configuration example of the optical modulator shown in FIG. 6.

FIG. 8 is a block diagram showing an example of each circuit configuration of a reference signal generator and a demodulation circuit shown in FIG. 4.

FIG. 9 is a block diagram showing an example of each circuit configuration of a reference signal generator and a demodulation circuit provided in a laser interferometer according to a modification of the second embodiment.

FIG. 10 is a functional block diagram showing a laser interferometer according to a third embodiment.

FIG. 11 is a functional block diagram showing a spectroscopic apparatus according to a fourth embodiment.

### DESCRIPTION OF EMBODIMENTS

Hereinafter, an optical modulator, a laser interferometer, and a spectroscopic apparatus of the disclosure will be described in detail based on embodiments shown in the accompanying drawings.

### 1. First Embodiment

First, an optical modulator and a laser interferometer according to a first embodiment will be described.

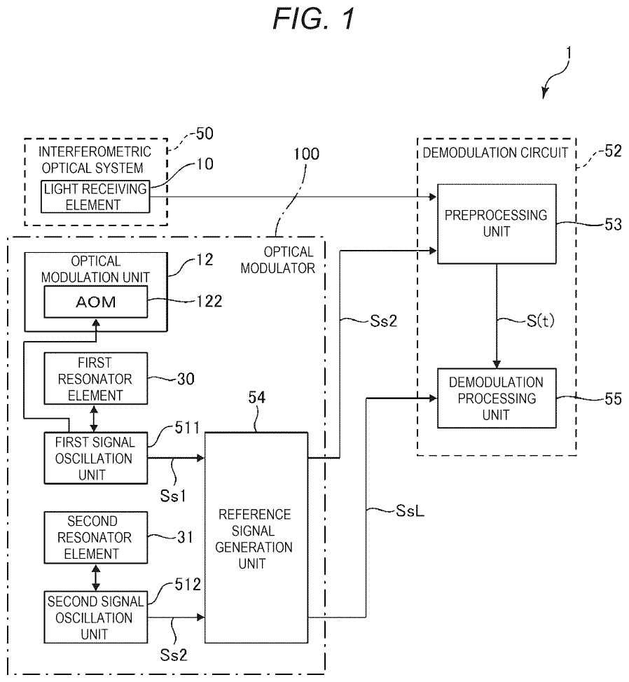

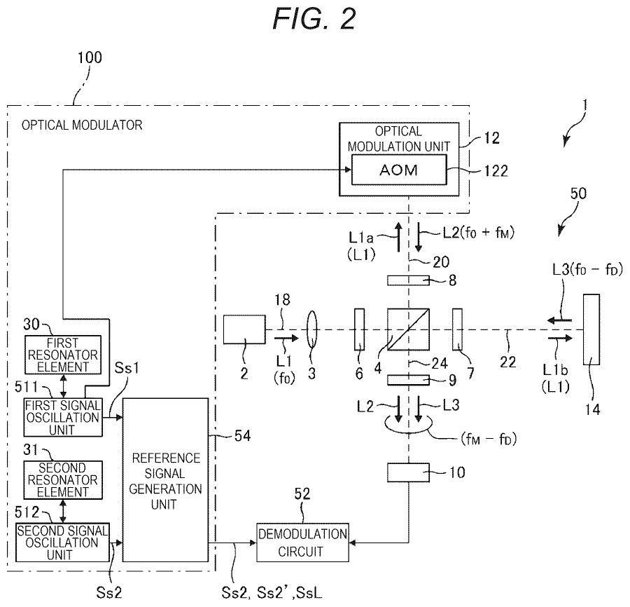

FIG. 1 is a functional block diagram showing a laser interferometer 1 according to the first embodiment. FIG. 2 is a schematic configuration diagram showing an optical modulator 100 and an interferometric optical system 50 shown in FIG. 1.

The laser interferometer 1 shown in FIG. 1 includes the interferometric optical system 50, the optical modulator 100, and a demodulation circuit 52.

The interferometric optical system 50 shown in FIG. 2 splits laser light emitted from a laser light source 2 and causes the laser light to be incident on a target object 14 and the optical modulator 100. Laser light beams returned from the target object 14 and the optical modulator 100 are mixed and received by a photodetector 10. The photodetector 10 detects a change in an intensity of the laser light including a sample signal (phase information added to the laser light) added by the target object 14 and a modulation signal (frequency information added to the laser light) added by the optical modulator 100, and outputs a laser light reception signal.

The demodulation circuit 52 shown in FIG. 1 includes a preprocessing unit 53 and a demodulation processing unit 55. The preprocessing unit 53 performs electrical preprocessing on the laser light reception signal based on a reference signal. The demodulation processing unit 55 demodulates the sample signal from the laser light reception signal subjected to the preprocessing. Accordingly, a displacement and velocity of the target object 14 can be measured.

The optical modulator 100 generates the reference signal having a frequency lower than a frequency of the modulation signal (modulation frequency). By using the reference signal, it is possible to reduce a frequency of a signal to be subjected to computational processing in the demodulation circuit 52. That is, a frequency band to be handled by the demodulation circuit 52 can be lower than the modulation frequency. Accordingly, a specification of the demodulation circuit 52 can be simplified, and cost of an electronic component and the like used in the demodulation circuit 52 can be reduced.

### 1.1. Interferometric Optical System

The interferometric optical system 50 shown in FIG. 2 is a Michelson interferometric optical system. As shown in FIG. 2, the interferometric optical system 50 includes the laser light source 2, a collimating lens 3, a light splitter 4, a half-wave plate 6, a quarter-wave plate 7, a quarter-wave plate 8, an analyzer 9, and the photodetector 10.

The laser light source 2 emits emission light L1 at a frequency f₀. The photodetector 10 converts an intensity of received light into an electrical signal. The optical modulator 12 includes an AOM 122 as will be described later. The AOM 122 is an acousto-optic modulator. The optical modulator 12 changes the frequency of the emission light L1 to generate reference light L2 (laser light where the modulation signal is superimposed) including the modulation signal. Meanwhile, the emission light L1 incident on the target object 14 is reflected as object light L3 including the sample signal derived from the target object 14 (laser light including the sample signal derived from the target object 14).

A light path connecting the light splitter 4 and the laser light source 2 is referred to as a light path 18. A light path connecting the light splitter 4 and the optical modulator 12 is referred to as a light path 20. A light path connecting the light splitter 4 and the target object 14 is referred to as a light path 22. A light path connecting the light splitter 4 and the photodetector 10 is referred to as a light path 24. A “light path” in the present specification represents a path that is set between optical components and along which light travels.

On the light path 18, the half-wave plate 6 and the collimating lens 3 are disposed in this order from the light splitter 4. The quarter-wave plate 8 is disposed on the light path 20. The quarter-wave plate 7 is disposed on the light path 22. The analyzer 9 is disposed on the light path 24.

The emission light L1 emitted from the laser light source 2 passes through the light path 18 and is split into two beams by the light splitter 4. First split light L1a that is one beam of the split emission light L1 passes through the light path 20 and is incident on the optical modulator 12. Second split light Lib that is the other beam of the split emission light L1 passes through the light path 22 and is incident on the target object 14. The reference light L2 generated by the optical modulator 12 by shifting the frequency passes through the light path and the light path 24 and is incident on the photodetector 10. The object light L3 generated by reflection on the target object 14 passes through the light path 22 and the light path 24 and is incident on the photodetector 10.

The laser interferometer 1 including the interferometric optical system 50 as described above obtains phase information of the target object 14 using an optical heterodyne interferometry method. Specifically, two light beams (the reference light L2 and the object light L3) with slightly different frequencies are caused to interfere with each other, and the phase information is extracted from obtained interference light. Then, the displacement of the target object 14 is obtained from the phase information in the demodulation circuit 52 to be described later. According to the optical heterodyne interferometry method, extraction of the phase information from the interference light is less susceptible to an influence of a disturbance, particularly to an influence of stray light at a frequency where the light becomes a noise, and thus high robustness is provided.

Hereinafter, each unit of the interferometric optical system 50 will be further described.

### 1.1.1. Laser Light Source

The laser light source 2 is a laser light source that emits the emission light L1 having interference capability. As the laser light source 2, a light source having a linewidth no higher than a MHz band is preferably used. Specific examples thereof include gas laser such as He—Ne laser, a semiconductor laser element such as a distributed feedback-laser diode (DFB-LD), a fiber Bragg grating laser diode (FBG-LD), a vertical cavity surface emitting laser (VCSEL), and a Fabry-Perot laser diode (FP-LD).

The laser light source 2 is particularly preferably a semiconductor laser element. Accordingly, it is possible to particularly reduce a size of the laser light source 2. Therefore, it is possible to reduce a size of the laser interferometer 1.

### 1.1.2. Collimating Lens

The collimating lens 3 is an optical element disposed between the laser light source 2 and the light splitter 4, and an example thereof is an aspherical lens. The collimating lens 3 collimates the emission light L1 emitted from the laser light source 2. When the emission light L1 emitted from the laser light source 2 is sufficiently collimated, for example, when gas laser such as He—Ne laser is used as the laser light source 2, the collimating lens 3 may be omitted.

The emission light L1 that becomes collimated light passes through the half-wave plate 6, thus is converted into linearly polarized light whose intensity ratio of P-polarized light to S-polarized light is, for example, 50:50, and is incident on the light splitter 4.

### 1.1.3. Light Splitter

The light splitter 4 is a polarization beam splitter disposed between the laser light source 2 and the optical modulator 12 and between the laser light source 2 and the target object 14. The light splitter 4 has a function of transmitting P-polarized light and reflecting S-polarized light. Due to this function, the light splitter 4 splits the emission light L1 into the first split light L1a that is light reflected by the light splitter 4 and the second split light L1b that is light transmitted by the light splitter 4.

The first split light L1a that is the S-polarized light reflected by the light splitter 4 is converted into circularly polarized light by the quarter-wave plate 8 and is incident on the optical modulator 12. The first split light L1a incident on the optical modulator 12 is subjected to a frequency shift at fₘ [Hz] and is emitted as the reference light L2. Therefore, the reference light L2 includes the modulation signal having the modulation frequency (first frequency f_{M}). That is, a frequency of the reference light L2 is f₀+f_{M}. The reference light L2 is converted into P-polarized light when passing through the quarter-wave plate 8 again. The P-polarized light of the reference light L2 is transmitted through the light splitter 4 and the analyzer 9 and is incident on the photodetector 10.

The second split light L1b that is P-polarized light transmitted through the light splitter 4 is converted by the quarter-wave plate 7 into circularly polarized light and is incident on the target object 14 in a moving state. The second split light L1b incident on the target object 14 is subjected to a Doppler shift at f_{d} [Hz] and is reflected as the object light L3. Therefore, the object light L3 includes a sample signal having the vibration frequency f_{d} [Hz]. That is, a frequency of the object light L3 is f₀−f_{D}. The object light L3 is converted into S-polarized light when passing through the quarter-wave plate 7 again. The S-polarized light of the object light L3 is reflected by the light splitter 4, passes through the analyzer 9, and is incident on the photodetector 10.

Since the emission light L1 has interference capability, the reference light L2 and the object light L3 are incident on the photodetector 10 as interference light.

### 1.1.4. Analyzer

Since S-polarized light and P-polarized light orthogonal to each other are independent of each other, simple superposition thereof does not result in appearance of beating due to interference. Therefore, a light wave that is superposition of the S-polarized light and the P-polarized light is passed through the analyzer 9 tilted by 450 with respect to both the S-polarized light and the P-polarized light. By using the analyzer 9, it is possible to transmit light beams having a common component to cause interference. As a result, the analyzer 9 causes interference between the reference light L2 and the object light L3, and interference light having a beating frequency of |f_{M}−f_{D}| is generated.

### 1.1.5. Photodetector

When the interference light is incident on the photodetector 10, the photodetector 10 outputs a photocurrent (laser light reception signal) corresponding to an intensity of the interference light. By demodulating the sample signal from the laser light reception signal using a method to be described later, a motion of the target object 14, that is, the displacement and the velocity can be finally obtained. An example of the photodetector 10 is a photodiode. The light received by the photodetector 10 is not limited to the interference light as long as the light is laser light emitted from the laser light source 2 and is laser light whose frequency and whose phase are modulated by the optical modulator 12 and the target object 14 such that the modulation signal and the sample signal are superimposed. In addition, the phrase “demodulating the sample signal from the laser light reception signal” in the present specification refers to demodulating the sample signal by performing various types of computation on the laser light reception signal.

### 1.2. Optical Modulator

The optical modulator 100 shown in FIG. 1 includes a first resonator 30, the optical modulator 12, a first signal oscillator 511, a second resonator 31, a second signal oscillator 512, and a reference signal generator 54.

### 1.2.1. First Resonator

The first resonator 30 vibrates at the first frequency f_{M}. The first resonator 30 is, for example, a resonator that generates a periodic signal, such as a quartz crystal resonator, a ceramic resonator, or a Si resonator. Since such a resonator is a resonator using a mechanical resonance phenomenon, the resonator has a high Q value and excellent vibration frequency stability. By inputting, to the AOM 122, a first signal output using the first resonator 30 as source oscillation from the first signal oscillator 511, the modulation signal having the first frequency can be added to the first split light L1a in the AOM 122.

Examples of a quartz crystal resonator include a quartz crystal AT resonator, an SC-cut quartz crystal resonator, a tuning fork type quartz crystal resonator, and a quartz crystal surface acoustic wave element. An oscillation frequency of the quartz crystal resonator is, for example, from 1 kHz to several hundreds of MHz.

A silicon resonator is a resonator including a single-crystal silicon piece manufactured from a single-crystal silicon substrate using an MEMS technology, and a piezoelectric film. Micro electro mechanical systems (MEMS) refer to micro-scale electro mechanical systems. Examples of a shape of the single-crystal silicon piece include a cantilever beam shape such as a two-legged tuning fork type and a three-legged tuning fork type, and a both-ended beam shape. An oscillation frequency of the silicon resonator is, for example, from 1 kHz to several hundreds of MHz.

A ceramic resonator is a resonator including an electrode and a piezoelectric ceramic piece manufactured by sintering a piezoelectric ceramic. Examples of the piezoelectric ceramic include lead zirconate titanate (PZT) and barium titanate (BTO). An oscillation frequency of the ceramic resonator is, for example, from several hundreds of kHz to several tens of MHz.

Among these, the quartz crystal resonator is preferably used as the first resonator 30. The quartz crystal resonator has particularly high frequency stability since quartz crystal is a piezoelectric material.

An oscillation frequency (first frequency f_{M}) of the first resonator 30 is not particularly limited, and is preferably 1 MHz or higher and 100 MHz or lower. In a frequency band within this range, there are a large number of resonators having a high mechanical resonance Q value. Therefore, by setting the first frequency f_{M} within this range, the first frequency f_{M} of a first signal Ss1 output from the first signal oscillator 511 can be stabilized.

### 1.2.2. Optical Modulator

The optical modulator 12 shown in FIGS. 1 and 2 includes the AOM 122 as described above. When a periodic signal output using the first resonator 30 as source oscillation is received by the AOM 122 and the first split light L1a is emitted to the AOM 122, the modulation signal having the first frequency f_{M} is added to the first split light L1a due to diffraction. When the AOM 122 is an element that transmits light, the first split light L1a can be returned to an incident direction by providing a reflector plate (not shown).

Instead of the AOM 122, another frequency shifter may be used, or a phase shifter such as an electro-optical modulator (EOM) may be used.

### 1.2.3. First Signal Oscillator

The first signal oscillator 511 generates, using the first resonator 30 as source oscillation, the first signal Ss1 at the first frequency f_{M}.

Examples of the first signal oscillator 511 include an oscillation circuit using an inverter and a Colpitts oscillation circuit. Such an oscillation circuit operates with fundamental mode oscillation of the first resonator 30 serving as source oscillation. Therefore, by using the first resonator 30 having a high mechanical resonance Q value, the first signal Ss1 having high frequency stability can be generated.

The first resonator 30 and the first signal oscillator 511 may be accommodated in one package. Examples of the first resonator 30 and the first signal oscillator 511 accommodated in one package include a quartz crystal oscillator (SPXO), a voltage-controlled quartz crystal oscillator (VCXO), a temperature-compensated quartz crystal oscillator (TCXO), and an oven-controlled quartz crystal oscillator (OCXO).

### 1.2.4. Second Resonator

The second resonator 31 vibrates at a second frequency f_{C}. The second resonator 31 is, for example, a resonator that generates a periodic signal, such as a quartz crystal resonator, a ceramic resonator, or a Si resonator. Since such a resonator is a resonator using a mechanical resonance phenomenon, the resonator has a high Q value and excellent vibration frequency stability.

Among these, the quartz crystal resonator is preferably used as the second resonator 31. The quartz crystal resonator has particularly high frequency stability since quartz crystal is a piezoelectric material.

An oscillation frequency (second frequency f_{C}) of the second resonator 31 is not particularly limited as long as the oscillation frequency is different from the first frequency f_{M}, and is preferably 1 MHz or higher and 100 MHz or lower. In a frequency band within this range, there are a large number of resonators having a high mechanical resonance Q value. Therefore, by setting the second frequency f_{C} within this range, the second frequency f_{C} of a second signal Ss2 output from the second signal oscillator 512 can be stabilized.

### 1.2.5. Second Signal Oscillator

The second signal oscillator 512 generates, using the second resonator 31 as source oscillation, the second signal Ss2 at the second frequency f_{C}.

Examples of the second signal oscillator 512 include an oscillation circuit using an inverter and a Colpitts oscillation circuit. Such an oscillation circuit operates with fundamental mode oscillation of the second resonator 31 serving as source oscillation. Therefore, by using the second resonator 31 having a high mechanical resonance Q value, the second signal Ss2 having high frequency stability can be generated.

The second resonator 31 and the second signal oscillator 512 may be accommodated in one package. Examples of the second resonator 31 and the second signal oscillator 512 accommodated in one package include a quartz crystal oscillator (SPXO), a voltage-controlled quartz crystal oscillator (VCXO), a temperature-compensated quartz crystal oscillator (TCXO), and an oven-controlled quartz crystal oscillator (OCXO).

### 1.2.6. Reference Signal Generator

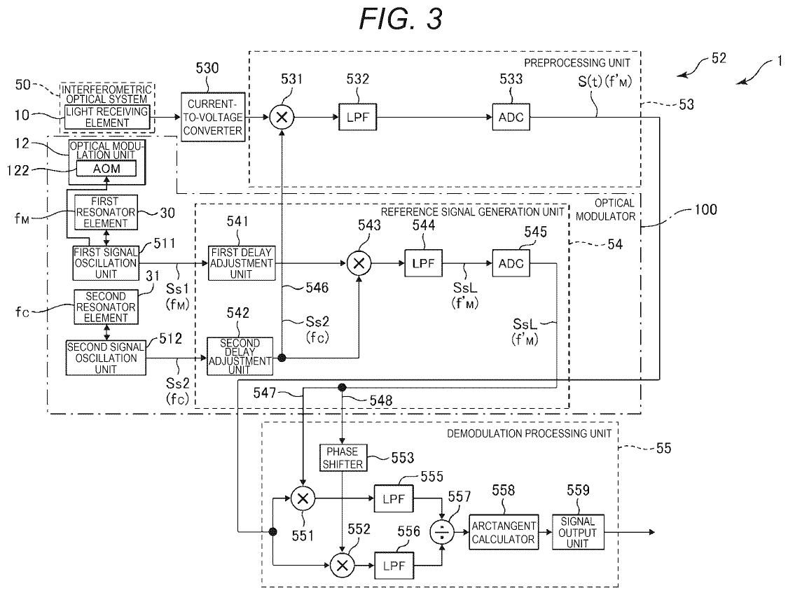

FIG. 3 is a block diagram showing an example of each circuit configuration of the reference signal generator 54 and the demodulation circuit 52 shown in FIG. 1.

The reference signal generator 54 shown in FIG. 3 multiplies the laser light reception signal including the modulation signal having the first frequency f_{M} by the second signal Ss2 at the second frequency f_{C}. Accordingly, a frequency of a signal to be subjected to computational processing in the preprocessing unit 53 in the demodulation circuit 52 can be lowered. The reference signal generator 54 multiplies the first signal Ss1 by the second signal Ss2 to generate a reference signal SsL at a frequency lower than the first frequency f_{M} and the second frequency f_{C}. The reference signal SsL is received by the demodulation processing unit 55 in the demodulation circuit 52. Accordingly, the frequency of the signal to be subjected to the computational processing in the demodulation processing unit 55 can be lowered. In the following description, lowering the frequency of the signal to be subjected to the computational processing is referred to as “down-conversion”.

The reference signal generator 54 includes a first delay adjustment unit 541, a second delay adjustment unit 542, a multiplier 543, a low-pass filter 544, an A/D converter 545, and multiplication wirings 546, 547, and 548. A configuration of the reference signal generator 54 is not limited thereto.

The first delay adjustment unit 541 and the second delay adjustment unit 542 adjust mutual delay between the first signal Ss1 output from the first signal oscillator 511 and the second signal Ss2 output from the second signal oscillator 512 in order to synchronize phases thereof.

The multiplier 543 multiplies a signal output from the first delay adjustment unit 541 by a signal output from the second delay adjustment unit 542. Accordingly, as a result of the multiplication, a signal having a frequency of a sum of the first frequency f_{M} and the second frequency f_{C} (sum frequency signal) and a signal having a frequency of a difference therebetween (difference frequency signal) are generated.

The low-pass filter 544 cuts the sum frequency signal from the signals in the multiplication result of the multiplier 543. Accordingly, the difference frequency signal can be extracted and used as the reference signal SsL. The low-pass filter 544 may be a band-pass filter.

The A/D converter 545 converts the analog difference frequency signal into a digital signal. Accordingly, the digital reference signal SsL is obtained. The frequency of the analog reference signal SsL received by the A/D converter 545 is lower than the first frequency f_{M} and the second frequency f_{C}. Therefore, a sampling frequency of the A/D converter 545 can be lowered, and thus cost of the A/D converter 545 can be reduced. The A/D converter 545 may be provided as necessary and may be omitted when the demodulation circuit 52 is implemented by an analog circuit, for example.

The multiplication wiring 546 is a path through which the second signal Ss2 is received by the preprocessing unit 53. Accordingly, the laser light reception signal and the second signal Ss2 can be multiplied in the preprocessing unit 53, and the signal to be subjected to the computational processing in the preprocessing unit 53 can be down-converted. As a result, an operating frequency of an electronic component such as a programmable logic device (FPGA), an application-specific integrated circuit (ASIC), or a microcomputer where the preprocessing unit 53 is installed can be lowered, and thus cost can be reduced.

The multiplication wirings 547 and 548 are paths through which the reference signal SsL output from the A/D converter 545 is received by the demodulation processing unit 55. Accordingly, the signal to be subjected to the computational processing in the demodulation processing unit 55 can be down-converted. As a result, an operating frequency of an electronic component where the demodulation processing unit 55 is installed can be lowered, and thus cost can be reduced.

The down-converted frequency is a difference between the first frequency f_{M} and the second frequency f_{C}. When the sampling frequency of the A/D converter, the operating frequency of the FPGA, or the like is taken into consideration, the frequency of the difference between the first frequency f_{M} and the second frequency f_{C} is preferably in a kHz band. As an example, it is assumed that the first frequency f_{M} is 40.00 MHz and the second frequency f_{C} is 39.95 MHz. In this case, a down-converted frequency f′_{M} is 50 kHz. In this case, low-pass filters 532, 544, 555, and 556 are set to cut a frequency exceeding 50 kHz.

In this example, the first frequency f_{M} is higher than the second frequency f_{C}, but this relationship may be reversed. In this case, by reversing positive and negative of a signal output from the demodulation circuit 52, the same value as that in the above example is obtained.

Meanwhile, when the displacement of the target object 14 is measured, the down-converted frequency f′_{M} affects a measurable velocity range and a measurable frequency range of the target object 14. That is, when the down-converted frequency f′_{M} is excessively low, these ranges may be narrowed. Therefore, the difference between the first frequency f_{M} and the second frequency f_{C} is preferably 1 kHz or more and less than 1 MHz, and more preferably 10 kHz or more and 500 kHz or less. Accordingly, it is possible to reduce cost of an electronic component such as the A/D converter or the FPGA while ensuring measurement performance suitable for a common measurement scene of the target object 14.

### 1.3. Demodulation Circuit

The demodulation circuit 52 shown in FIG. 3 includes a current-to-voltage converter 530, the preprocessing unit 53, and the demodulation processing unit 55.

### 1.3.1. Current-to-Voltage Converter

The current-to-voltage converter 530 is also called a transimpedance amplifier (TIA), which converts the photocurrent output from the photodetector 10 into a voltage signal and outputs the voltage signal as the laser light reception signal.

### 1.3.2. Preprocessing Unit

The preprocessing unit 53 shown in FIG. 3 down-converts the laser light reception signal output from the current-to-voltage converter 530 and performs digital conversion. In this specification, computation performed by the preprocessing unit 53 is also referred to as “preprocessing”.

The preprocessing unit 53 includes a multiplier 531, the low-pass filter 532, and an A/D converter 533.

The multiplier 531 multiplies the laser light reception signal output from the current-to-voltage converter 530 by the second signal Ss2 received via the multiplication wiring 546. Accordingly, as a result of the multiplication, a signal having a frequency of a sum of the laser light reception signal and the second signal Ss2 (sum frequency signal) and a signal having a frequency of a difference therebetween (difference frequency signal) are generated.

The low-pass filter 532 cuts the sum frequency signal from the signals in the multiplication result of the multiplier 531. Accordingly, the difference frequency signal can be extracted. The low-pass filter 532 may be a band-pass filter.

The A/D converter 533 converts the analog difference frequency signal into a digital signal. Accordingly, a digital difference frequency signal is obtained, which is referred to as a preprocessed signal S(t). The A/D converter 533 may be provided as necessary and may be omitted when the demodulation processing unit 55 is implemented by an analog circuit, for example.

### 1.3.3. Demodulation Processing Unit

The demodulation processing unit 55 shown in FIG. 3 performs demodulation processing on the preprocessed signal S(t) output from the preprocessing unit 53, demodulates the sample signal, and calculates the displacement, the velocity, and the like of the target object 14. For example, a known quadrature detection method is used for the demodulation processing.

The demodulation processing unit 55 shown in FIG. 3 is a digital circuit including a multiplier 551, a multiplier 552, a phase shifter 553, the low-pass filter 555, the low-pass filter 556, a divider 557, an arctangent calculator 558, and a signal output unit 559.

The preprocessed signal S(t) is divided into two parts. One part passes through the multiplier 551 and the low-pass filter 555 and is received by the divider 557. The other part passes through the multiplier 552 and the low-pass filter 556 and is received by the divider 557.

The multiplier 551 multiplies the one part of the preprocessed signal S(t) by the reference signal SsL. The multiplier 552 multiplies the other part of the preprocessed signal S(t) by a signal output from the phase shifter 553. The phase shifter 553 generates an output signal obtained by inverting a phase of the received reference signal SsL without changing an amplitude.

Each of the low-pass filter 555 and the low-pass filter 556 is a filter that cuts a signal in a high frequency band.

The divider 557 divides a signal output from the low-pass filter 556 by a signal output from the low-pass filter 555.

The arctangent calculator 558 performs arctangent calculation on a signal output from the divider 557 to calculate a phase as sample information derived from the target object 14.

The signal output unit 559 performs phase connection such as unwrapping on the phase derived from the target object 14 and calculates the displacement of the target object 14. The velocity of the target object 14 is also calculated as necessary.

The circuit configuration of the demodulation processing unit 55 described above is an example, and the configuration is not limited thereto. For example, the demodulation processing unit 55 is not limited to be a digital circuit, and may be an analog circuit. The analog circuit may include an F/V converter circuit or a AZ counter circuit.

### 2. Second Embodiment

Next, an optical modulator and a laser interferometer according to a second embodiment will be described.

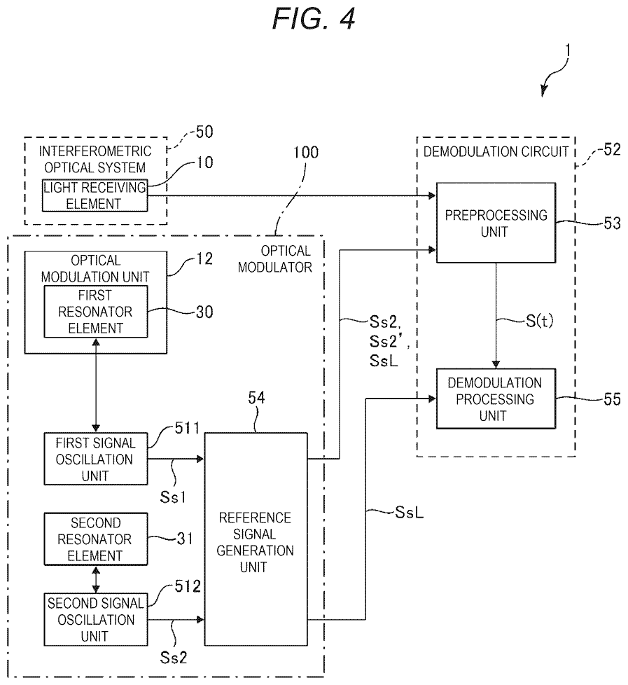

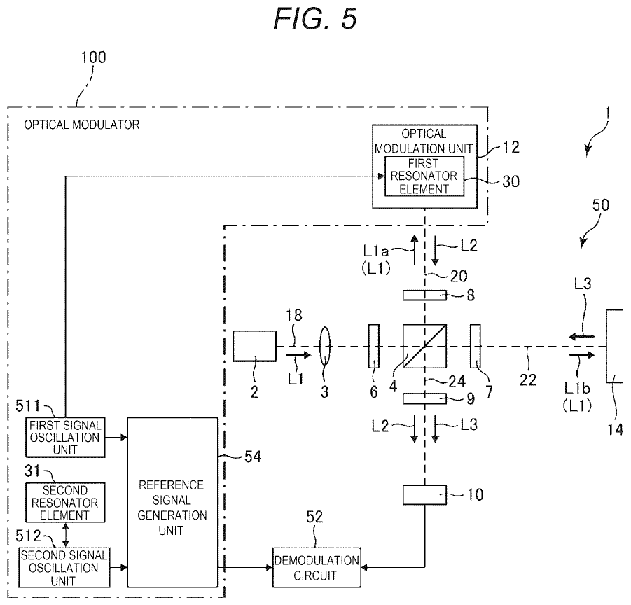

FIG. 4 is a functional block diagram showing the laser interferometer 1 according to the second embodiment. FIG. 5 is a schematic configuration diagram showing the optical modulator 100 and the interferometric optical system 50 shown in FIG. 4.

Hereinafter, the second embodiment will be described, and in the following description, differences from the above-described embodiment will be primarily described, and description of the same items will be omitted. In the drawings showing the present embodiment, the same reference numerals are given to the same configurations as those in the above-described embodiment.

The second embodiment is the same as the first embodiment except for the configuration of the optical modulator 100 and the configuration of the preprocessing unit 53.

### 2.1. Optical Modulator

In the optical modulator 100 shown in FIG. 4, the optical modulator 12 includes the first resonator 30 instead of the AOM 122. As shown in FIG. 5, the optical modulator 12 modulates the frequency of the first split light L1a using the first resonator 30.

According to such a configuration, since the AOM 122 can be omitted, it is possible to reduce a size, a weight, and power consumption of the optical modulator 100.

By modulating the frequency of the first split light L1a using the first resonator 30, vibration energy of the first resonator 30 causes both the modulation signal added to the reference light L2 and the first signal Ss1 output from the first signal oscillator 511 using the first resonator 30 as source oscillation. Therefore, even when vibration of the first resonator 30 changes due to a disturbance such as an impact or a noise applied to the optical modulator 100, both the modulation signal and the first signal Ss1 change similarly. Thus, it is possible to counter or reduce an influence of the disturbance on both of the signals in the process of the computational processing in the demodulation circuit 52. As a result, a decrease in a signal-to-noise ratio (S/N ratio) of the sample signal demodulated by the demodulation circuit 52 can be limited.

### 2.1.1. Optical Modulator

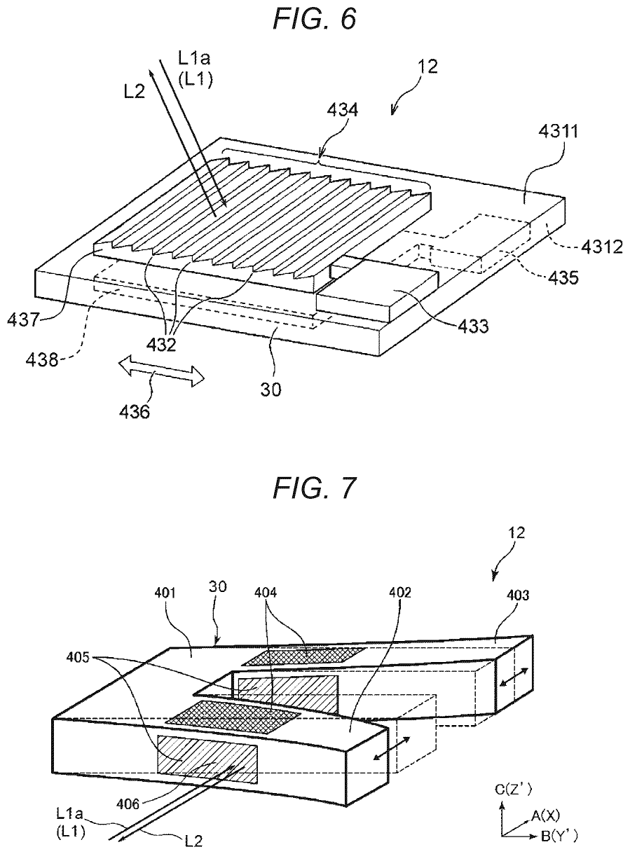

FIG. 6 is a perspective view showing the optical modulator 12 provided in the optical modulator 100 according to the second embodiment.

An example of the optical modulator 12 shown in FIG. 6 is an optical modulator disclosed in JP-A-2022-38156.

Specifically, the optical modulator 12 shown in FIG. 6 includes the first resonator 30 and a diffraction grating 434 provided at the first resonator 30 to diffract the first split light L1a (split laser light).

The first resonator 30 shown in FIG. 6 is a quartz crystal AT resonator that performs thickness-shear vibration along a vibration direction 436 in a high-frequency range in a MHz band. The diffraction grating 434 is provided at the first resonator 30. The diffraction grating 434 has a plurality of linear grooves 432 extending in a direction intersecting the vibration direction 436. When the first split light L1a is emitted to such a diffraction grating 434, the frequency of the first split light L1a can be modulated to generate the reference light L2 even when the first resonator 30 performs the thickness-shear vibration.

The first resonator 30 has a front surface 4311 and a back surface 4312, which are in a front-and-back relationship with each other. The diffraction grating 434 is disposed at the front surface 4311. A first electrode 437 for applying a potential to the first resonator 30 and a pad 433 electrically coupled to the first electrode 437 are also provided at the front surface 4311. Meanwhile, a second electrode 438 for applying a potential to the first resonator 30 and a pad 435 electrically coupled to the second electrode 438 are provided at the back surface 4312. The first electrode 437 and the second electrode 438 overlap each other with the first resonator 30 interposed therebetween when the front surface 4311 is viewed in a plan view. The pads 433 and 435 do not overlap each other with the first resonator 30 interposed therebetween. When a voltage is applied between the first electrode 437 and the second electrode 438, thickness-shear vibration is induced at a portion where the first electrode 437 and the second electrode 438 overlap each other.

The diffraction grating 434 shown in FIG. 6 is disposed on the first electrode 437. That is, in FIG. 6, the diffraction grating 434 is configured with the plurality of grooves 432 formed on a front surface of the first electrode 437, and when the first split light L1a is emitted thereto, the reference light L2 is emitted as diffracted light.

The diffraction grating 434 shown in FIG. 6 is, for example, a blazed diffraction grating. The blazed diffraction grating is a diffraction grating having a sawtooth-shaped cross-section. The shape of the diffraction grating 434 is not limited thereto.

FIG. 7 is a perspective view showing another configuration example of the optical modulator 12 shown in FIG. 6. In FIG. 7, an A-axis, a B-axis, and a C-axis are set as three axes orthogonal to each other, and are indicated by arrows. A tip end side of an arrow is defined as a “positive side”, and a base end side of the arrow is defined as a “negative side”.

The first resonator 30 shown in FIG. 7 is a tuning fork type quartz crystal resonator. The first resonator 30 shown in FIG. 7 includes a vibration substrate including a base portion 401, a first vibrating arm 402, and a second vibrating arm 403. Such a tuning fork type quartz crystal resonator is readily available and produces stable oscillation since a technology for manufacturing the resonator has been established. Therefore, the tuning fork type quartz crystal resonator is suitable as the first resonator 30. The optical modulator 12 shown in FIG. 7 includes the first resonator 30, and electrodes 404 and 405 and a light reflector 406 provided at the first resonator 30.

The base portion 401 is a portion extending along the A-axis. The first vibrating arm 402 is a portion extending from an end of the base portion 401 on the negative side of the A-axis toward the positive side of the B-axis. The second vibrating arm 403 is a portion extending from an end of the base portion 401 on the positive side of the A-axis toward the positive side of the B-axis.

The electrodes 404 are electrically conductive films provided at side surfaces parallel to an A-B plane of the first vibrating arm 402 and the second vibrating arm 403. Although not shown in FIG. 7, the electrodes 404 are provided at side surfaces facing each other, and drive the first vibrating arm 402 and the second vibrating arm 403 when voltages having different polarities are applied thereto.

The electrodes 405 are electrically conductive films provided at side surfaces intersecting the A-B plane of the first vibrating arm 402 and the second vibrating arm 403. Although not shown in FIG. 7, the electrodes 405 are also provided at side surfaces facing each other, and drive the first vibrating arm 402 and the second vibrating arm 403 when voltages having different polarities are applied thereto.

The light reflector 406 is set at a side surface intersecting the A-B plane of the first vibrating arm 402 and the second vibrating arm 403, and has a function of reflecting the first split light L1a. With this function, since the light reflector 406 has a vibration component having a large amplitude in the incident direction of the incident first split light L1a, it is possible to efficiently modulate the frequency of the first split light L1a and generate the reference light L2.

As the tuning fork type quartz crystal resonator, a quartz crystal piece cut from a quartz crystal substrate is used. An example of the quartz crystal substrate used to manufacture the tuning fork type quartz crystal resonator is a quartz crystal Z-cut flat plate. An X-axis parallel to the A-axis, a Y′-axis parallel to the B-axis, and a Z′-axis parallel to the C-axis are set in FIG. 7. The quartz crystal Z-cut flat plate is, for example, a substrate cut from a single crystal of quartz crystal such that the X-axis is an electrical axis, the Y′-axis is a mechanical axis, and the Z′-axis is an optical axis. Specifically, in an orthogonal coordinate system including the X-axis, the Y′-axis and the Z′-axis, a substrate having a principal surface inclining with respect to an X-Y′ plane containing the X-axis and the Y′-axis by about 1° to 5° in a counterclockwise direction around the X-axis is cut from the single crystal of quartz crystal and is preferably used as the quartz crystal substrate. Such a quartz crystal substrate is then etched to obtain a quartz crystal piece to be used as the first resonator 30 shown in FIG. 7.

### 2.1.2. Reference Signal Generator

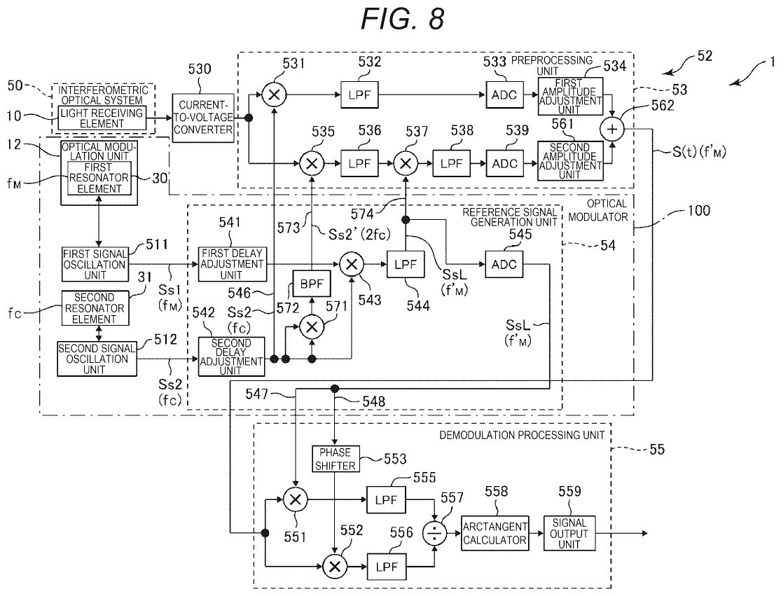

FIG. 8 is a block diagram showing an example of each circuit configuration of the reference signal generator 54 and the demodulation circuit 52 shown in FIG. 4.

The reference signal generator 54 shown in FIG. 8 includes the first delay adjustment unit 541, the second delay adjustment unit 542, the multiplier 543, the low-pass filter 544, the A/D converter 545, the multiplication wirings 546, 547, and 548, a multiplier 571, a band-pass filter 572, and multiplication wirings 573 and 574. The configuration of the reference signal generator 54 is not limited thereto.

The multiplier 571 squares the signal output from the second delay adjustment unit 542. A signal output from the multiplier 571 is referred to as a second signal Ss2′. A frequency of the second signal Ss2′ is 2f_{C}. The band-pass filter 572 allows only a signal in a predetermined frequency band in the signal output from the multiplier 571 to pass therethrough. The multiplication wiring 573 is a path through which a signal output from the band-pass filter 572 is received by the preprocessing unit 53. The multiplication wiring 574 is a path through which a signal output from the low-pass filter 544 is received by the preprocessing unit 53.

### 2.2. Demodulation Circuit

The demodulation circuit 52 shown in FIG. 8 includes the current-to-voltage converter 530, the preprocessing unit 53, and the demodulation processing unit 55.

### 2.2.1. Preprocessing Unit

The preprocessing unit 53 shown in FIG. 8 down-converts the laser light reception signal output from the current-to-voltage converter 530, converts a sample signal (phase information or the like derived from the target object 14) into a demodulatable state by a known quadrature detection method, and converts the sample signal into a digital signal.

The preprocessing unit 53 shown in FIG. 8 includes the multiplier 531, the low-pass filter 532, the A/D converter 533, a first amplitude adjustment unit 534, a multiplier 535, a low-pass filter 536, a multiplier 537, a low-pass filter 538, an A/D converter 539, a second amplitude adjustment unit 561, and an adder 562. The configuration of the preprocessing unit 53 is not limited thereto. For example, a delay adjustment unit may be provided at any position.

The laser light reception signal received by the preprocessing unit 53 is divided into two parts. One part passes through the multiplier 531, the low-pass filter 532, the A/D converter 533, and the first amplitude adjustment unit 534, and is received by the adder 562. The other part passes through the multiplier 535, the low-pass filter 536, the multiplier 537, the low-pass filter 538, the A/D converter 539, and the second amplitude adjustment unit 561, and is received by the adder 562.

The multiplier 531 multiplies the one part of the laser light reception signal by the second signal Ss2 received via the multiplication wiring 546. Accordingly, as a result of the multiplication, a signal having a frequency of a sum of the laser light reception signal and the second signal Ss2 (sum frequency signal) and a signal having a frequency of a difference therebetween (difference frequency signal) are generated.

The low-pass filter 532 cuts the sum frequency signal from the signals in the multiplication result of the multiplier 531. Accordingly, the difference frequency signal can be extracted. The low-pass filter 532 may be a band-pass filter.

The A/D converter 533 converts the analog difference frequency signal into a digital signal. Accordingly, the digital difference frequency signal is obtained.

The first amplitude adjustment unit 534 adjusts a signal amplitude to match that of the second amplitude adjustment unit 561.

The multiplier 535 multiplies the other part of the laser light reception signal by the second signal Ss2′ received via the multiplication wiring 573. Accordingly, as a result of the multiplication, a signal having a frequency of a sum of the laser light reception signal and the second signal Ss2′ (sum frequency signal) and a signal having a frequency of a difference therebetween (difference frequency signal) are generated.

The low-pass filter 536 cuts the sum frequency signal from the signals in the multiplication result of the multiplier 535. Accordingly, the difference frequency signal can be extracted. The low-pass filter 536 may be a band-pass filter.

The multiplier 537 multiplies a signal output from the low-pass filter 536 by the reference signal SsL received via the multiplication wiring 574. Accordingly, as a result of the multiplication, a signal having a frequency of a sum of the signal output from the low-pass filter 536 and the reference signal SsL (sum frequency signal) and a signal having a frequency of a difference therebetween (difference frequency signal) are generated.

The low-pass filter 538 cuts the sum frequency signal from the signals in the multiplication result of the multiplier 537. Accordingly, the difference frequency signal can be extracted. The low-pass filter 538 may be a band-pass filter.

The A/D converter 539 converts the analog difference frequency signal into a digital signal. Accordingly, the digital difference frequency signal is obtained.

The second amplitude adjustment unit 561 adjusts a signal amplitude to match that of the first amplitude adjustment unit 534.

The adder 562 adds a signal output from the first amplitude adjustment unit 534 to a signal output from the second amplitude adjustment unit 561. A result of such addition is referred to as the preprocessed signal S(t).

### 2.2.2. Preprocessing

Next, preprocessing performed by the preprocessing unit 53 will be described. In the following description, as an example, a system in which a signal whose frequency changes in a sinusoidal manner is used as the modulation signal and the displacement of the target object 14 performs simple harmonic oscillation along an optical axis direction will be described.

An AC component I_{PD.AC} of the laser light reception signal received by the preprocessing unit 53 is represented by the following formula (1).

$$\begin{matrix}Math 1 & \\ {I}_{PD . A C} = A cos ( {Φ}_{M} - X ) & ( 1 )\end{matrix}$$

In the formula (1), A represents an amplitude. In addition, Φ_{M} is a phase derived from the optical modulator 12, and X is given by the following formula (1a).

$$\begin{matrix}Math 2 & \\ X = {Φ}_{S} - {Φ}_{0} & ( 1 a )\end{matrix}$$

In the formula (1a), Φ_{S} is a phase derived from the target object 14, and Φ₀ is an initial phase difference due to a light path difference in the interferometric optical system 50.

The optical modulator 12 shown in FIG. 8 modulates a frequency of incident laser light using the first resonator 30 that vibrates at the first frequency f_{M}. Therefore, Φ_{M} is given by the following formula (1b).

$$\begin{matrix}Math 3 & \\ {Φ}_{M} = B sin 2 π {f}_{M} t & ( 1 b )\end{matrix}$$

In the formula (1b), B is a modulation phase shift in frequency modulation by the optical modulator 12, and t is time.

The multiplier 531 multiplies the AC component I_{PD.AC} of the laser light reception signal by the second signal Ss2 received via the multiplication wiring 546. A multiplication result Iₕₑₜ₁ is given by the following formula (1c).

$$\begin{matrix}Math 4 & \\ {I}_{h e t 1} = A cos ( B sin 2 π {f}_{M} t - X ) \cdot cos 2 π {f}_{C} t & ( 1 c )\end{matrix}$$

As in the formula (1c), the AC portion I_{PD.AC} of the laser light reception signal received by the preprocessing unit 53 shown in FIG. 8 is represented by a mathematical expression in which an angular part of a trigonometric function (cos) further includes a trigonometric number (sin) whose angular part changes over time. In this case, the mathematical expression of the AC portion I_{PD.AC} of the laser light reception signal can be expanded using a series expansion of a Bessel function.

When the multiplication result Iₕₑₜ₁ in the multiplier 531 passes through the low-pass filter 532, a frequency component corresponding to a first-order term of the series expansion can be extracted. As a result, a signal I_{LPF1} after the multiplication result Iₕₑₜ₁ passes through the low-pass filter 532 is represented by the following formula (2).

$$\begin{matrix}Math 5 & \\ {t}_{LPF 1} = {J}_{1} ( B ) sin 2 π {f}_{M}^{′} t \cdot sin X & ( 2 )\end{matrix}$$

In the formula (2), J₁(B) is a coefficient of the first-order term in the series expansion of the Bessel function. That is, the formula (2) is the first-order term extracted by expanding the multiplication result Iₕₑₜ₁ represented by the formula (1c) using the series expansion of the Bessel function.

In addition, f′_{M} represents a frequency down-converted by multiplication by the multiplier 531. That is, since the difference frequency signal is extracted by passing the multiplication result through the low-pass filter 532, f′_{M} is defined by the following formula (2a).

$$\begin{matrix}Math 6 & \\ {f}_{M}^{′} = \vert {f}_{M} - {f}_{C} \vert & ( 2 a )\end{matrix}$$

In the formula (2a), f_{M} is the frequency of the first signal Ss1 (first frequency), and f_{C} is the frequency of the second signal Ss2 (second frequency). As can be seen from the formula (2a), a frequency can be lowered by f_{C} by multiplying the AC component I_{PD.AC} by the second signal Ss2 in the multiplier 531.

Meanwhile, the multiplier 535 multiplies the AC component I_{PD.AC} of the laser light reception signal by the second signal Ss2′ received via the multiplication wiring 573. A multiplication result Iₕₑₜ₂ is given by the following formula (1d).

$$\begin{matrix}Math 7 & \\ {I}_{h e t 2} = A cos ( B sin 2 π {f}_{M} t - X ) \cdot cos 4 π {f}_{C} t & ( 1 d )\end{matrix}$$

When the multiplication result Iₕₑₜ₂ in the multiplier 535 passes through the low-pass filter 536, a frequency component corresponding to a second-order term of the series expansion can be extracted. As a result, a signal I_{LPF2} after the multiplication result Iₕₑₜ₂ passes through the low-pass filter 536 is represented by the following formula (3).

$$\begin{matrix}Math 8 & \\ {I}_{LPF 2} = {J}_{2} ( B ) cos 4 π {f}_{M}^{′} t \cdot cos X & ( 3 )\end{matrix}$$

In the formula (3), J₂ (B) is a coefficient of the second-order term in the series expansion of the Bessel function. That is, the formula (3) is the second-order term extracted by expanding the multiplication result Iₕₑₜ₂ represented by the formula (1d) using the series expansion of the Bessel function.

As described above, by providing the multipliers 531 and 535, the frequency of the AC component I_{PD.AC} of the laser light reception signal can be down-converted to f′_{M}.

The multiplier 537 multiplies the signal I_{LPF2} after passing through the low-pass filter 536 by the reference signal SsL. A signal I_{LPF3} after the multiplication result passes through the low-pass filter 538 is represented by the following formula (4).

$$\begin{matrix}Math 9 & \\ {I}_{LPF 3} = \frac{{J}_{2} ( B )}{2} cos 2 π {f}_{M}^{′} t \cdot cos X & ( 4 )\end{matrix}$$

Thereafter, the signal I_{LPF1} passes through the A/D converter 533 and then is multiplied by −J₂(B) in the first amplitude adjustment unit 534, thereby adjusting the amplitude.

The signal I_{LPF3} passes through the A/D converter 539 and is then multiplied by 2J₁ (B) in the second amplitude adjustment unit 561, thereby adjusting the amplitude.

The adder 562 adds the signal I_{LPF1} whose amplitude is adjusted to the signal I_{LPF3} whose amplitude is adjusted. Accordingly, the preprocessed signal S(t) is obtained. The preprocessed signal S(t) is represented by the following formula (5).

$$\begin{matrix}Math 10 & \\ \begin{matrix}S ( t ) = - sin 2 π {f}_{M}^{′} t \cdot sin X + cos 2 π {f}_{M}^{′} t \cdot cos X \\ = cos ( 2 π {f}_{M}^{′} t - X )\end{matrix} & ( 5 )\end{matrix}$$

As described above, the preprocessed signal S(t) whose frequency is down-converted is obtained.

Here, a case where the first frequency f_{M} is 4.97 MHz and the second frequency f_{C} is 4.92 MHz will be described as a specific example. In this case, a frequency of a signal output from the low-pass filter 532 of the preprocessing unit 53 is 50 kHz, and a frequency of the signal output from the low-pass filter 536 is 100 kHz. Therefore, in this case, the low-pass filters 532, 538, 544, 555, and 556 are set to cut a frequency exceeding 50 kHz, and the low-pass filter 536 is set to cut a frequency exceeding 100 kHz. The band-pass filter 572 is set to allow 9.84 MHz corresponding to twice the second frequency f_{C} to pass therethrough.

### 2.2.3. Demodulation Processing Unit

The demodulation processing unit 55 shown in FIG. 8 is the same as the demodulation processing unit 55 shown in FIG. 3. The preprocessed signal S(t) output from the preprocessing unit 53 is subjected to demodulation processing to demodulate X in the formula (5). Here, X is defined by Φ_{S}-Φ₀. Assuming that Φ₀ is constant, a change in Φ_{S} (the phase derived from the target object 14) is obtained. As described above, the displacement, the velocity, and the like of the target object 14 can be measured.

### 3. Modification of Second Embodiment

Next, an optical modulator and a laser interferometer according to a modification of the second embodiment will be described.

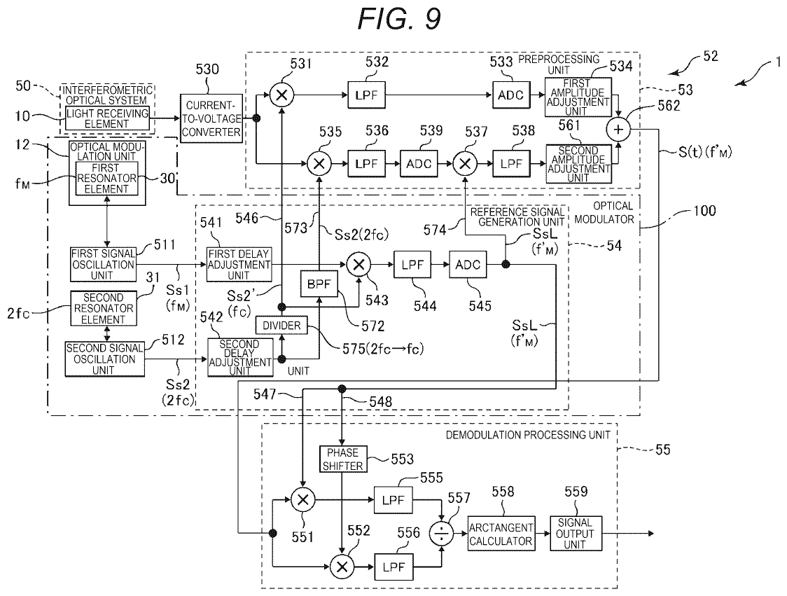

FIG. 9 is a block diagram showing an example of each circuit configuration of the reference signal generator 54 and the demodulation circuit 52 provided in the laser interferometer 1 according to the modification of the second embodiment.

The modification of the second embodiment will be described below, and in the following description, differences from the second embodiment will be primarily described, and description of the same items will be omitted. In FIG. 9, the same reference numerals are given to the same configurations as those in FIG. 8.

The modification of the second embodiment is the same as the second embodiment except for the configuration of the reference signal generator 54 and the configuration of the preprocessing unit 53. Hereinafter, differences from the second embodiment will be described.

In the present modification, the second frequency is set to 2f_{C}, which is twice as high as in the second embodiment. As an example, when the second frequency f_{C} in the second embodiment is 4.92 MHz, the second frequency 2f_{C} is 9.84 MHz in the present modification.

In the present modification, the multiplier 571 for squaring the signal output from the second delay adjustment unit 542 is omitted in the reference signal generator 54. Accordingly, the number of components in an analog circuit can be reduced. The second signal Ss2 is received by the preprocessing unit 53 at the same frequency (second frequency 2f_{C}) via the multiplication wiring 573.

Further, in the present modification, a divider 575 is provided in the middle of the multiplication wiring 546 in the reference signal generator 54. The divider 575 can reduce a received frequency to an integer fraction and output the reduced frequency. In the present modification, the frequency is reduced by ½ in the divider 575. Accordingly, the frequency of the second signal Ss2′ output from the divider 575 is f_{C}.

In the present modification, a position of the A/D converter 539 provided in the preprocessing unit 53 is changed to a position between the low-pass filter 536 and the multiplier 537. Similarly, a position of the A/D converter 545 provided in the reference signal generator 54 is changed to a position immediately after the low-pass filter 544 (between the low-pass filter 544 and a branch point where the signal output from the low-pass filter 544 is branched). Due to this change, the multiplier 537 provided in the preprocessing unit 53 can be changed from analog to digital, and the number of analog multipliers can be reduced accordingly. Accordingly, it is possible to reduce a probability that a noise is mixed in an analog multiplier, and it is possible to limit a decrease in an S/N ratio of the preprocessed signal S(t).

Here, as an example, it is assumed that the first frequency f_{M} is 4.97 MHz and the second frequency 2f_{C} is 9.84 MHz. In this case, the frequency of the signal output from the low-pass filter 532 of the preprocessing unit 53 is 50 kHz, and the frequency of the signal output from the low-pass filter 536 is 100 kHz. Therefore, in this case, the low-pass filters 532, 538, 544, 555, and 556 are set to cut a frequency exceeding 50 kHz, and the low-pass filter 536 is set to cut a frequency exceeding 100 kHz. The band-pass filter 572 is set to allow 9.84 MHz, which is the second frequency 2f_{C}, to pass therethrough.

### 4. Third Embodiment

Next, an optical modulator and a laser interferometer according to a third embodiment will be described.

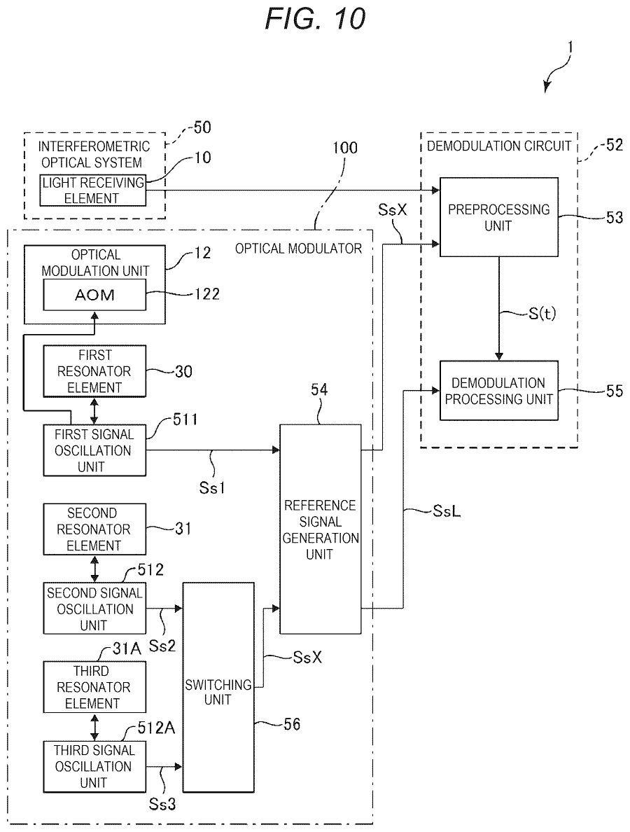

FIG. 10 is a functional block diagram showing the laser interferometer 1 according to the third embodiment.

The third embodiment will be described below, and in the following description, differences from the first embodiment will be primarily described, and description of the same items will be omitted. In FIG. 10, the same reference numerals are given to the same configurations as those in FIG. 1.

The third embodiment is the same as the first embodiment except for the configuration of the optical modulator 100. Hereinafter, differences from the first embodiment will be described.

In the third embodiment, the optical modulator 100 shown in FIG. 10 includes a third resonator 31A in addition to the first resonator 30 and the second resonator 31. In the third embodiment, the optical modulator 100 includes a third signal oscillator 512A in addition to the first signal oscillator 511 and the second signal oscillator 512. Further, in the third embodiment, the optical modulator 100 includes a switch 56.

The third resonator 31A is, for example, a resonator that generates a periodic signal, such as a quartz crystal resonator, a ceramic resonator, or a Si resonator. Since such a resonator is a resonator using a mechanical resonance phenomenon, the resonator has a high Q value and excellent vibration frequency stability.

An oscillation frequency (third frequency) of the third resonator 31A is not particularly limited, and is preferably 1 MHz or higher and 100 MHz or lower. In a frequency band within this range, there are a large number of resonators having a high mechanical resonance Q value. Therefore, by setting the third frequency within this range, the third frequency of a third signal Ss3 output from the third signal oscillator 512A can be stabilized.

The switch 56 is configured to switch a connection destination in order to select a selection signal SsX to be input to the reference signal generator 54 from a plurality of signals (the second signal Ss2 or the third signal Ss3). Specifically, the second signal Ss2 output from the second signal oscillator 512 and the third signal Ss3 output from the third signal oscillator 512A are received by the switch 56. The switch 56 selects the second signal Ss2 or the third signal Ss3 and inputs the selected signal as the selection signal SsX to the reference signal generator 54. The number of signals selected by the switch 56 is not limited to two, and may be three or more.

The reference signal generator 54 is similar to the reference signal generator 54 in the first embodiment except that the selection signal SsX is used instead of the second signal Ss2 in the first embodiment. According to such a configuration, the frequency f′_{M} after the down-conversion in the reference signal generator 54 and the preprocessing unit 53 can be switched. Accordingly, the optimum frequency f′_{M} can be selected according to a vibration characteristic of the target object 14. As a result, it is possible to obtain the laser interferometer 1 that can acquire optimum measurement data according to the vibration characteristic of the target object 14. Specifically, when the target object 14 has a low vibration frequency (vibrates slowly), it is necessary to ensure sufficient data measurement time in order to accurately grasp the vibration characteristic. However, since a data length (the number of data points) has an upper limit, sufficient data measurement time may not be ensured when a sampling frequency of the demodulation circuit 52 is high.

In this regard, in the present embodiment, by lowering the sampling frequency of the demodulation circuit 52 by down-conversion, it is possible to ensure long data measurement time even with the same data length. Therefore, even for the target object 14 having a low vibration frequency, measurement data having an appropriate length can be acquired.

As an example, when the frequency of the signal subjected to the computational processing in the demodulation circuit 52 is set to 5 MHz without down-conversion, the sampling frequency of the demodulation circuit 52 is required to be about 100 MHz. When it is assumed that an upper limit value of the data length is 1,000,000 points, only 10 milliseconds can be ensured as the data measurement time. In this case, it is difficult to accurately measure the vibration characteristic for the target object 14 that vibrates at a slow frequency of, for example, 100 Hz or lower.

On the other hand, when the vibration frequency to be subjected to the computational processing in the demodulation circuit 52 is down-converted to 1 kHz, the sampling frequency of about 20 kHz for the demodulation circuit 52 is sufficient. Therefore, data measurement time of 50 seconds can be ensured. In this case, the vibration characteristic can be accurately measured even for the target object 14 that vibrates at a fairly slow frequency of, for example, 1 Hz.

The following Table 1 lists the frequency f′_{M} after down-conversion and an example of a measurement target (an example of a measurable vibration characteristic of the target object) when the first frequency f_{M} is 4.97 MHz and the second frequency f_{C} is changed in five steps.

TABLE 1

| First frequency | Second frequency | Frequency f′_{M} [kHz] | |
|---|---|---|---|
| f_{M} [MHz] | f_{C} [MHz] | after down-conversion | Example of measurement target |
| 4.97 | 4.47 | 500 | Vibration of MEMS device |
| | 4.92 | 50 | Industrial displacement measurement |
| | 4.969 | 1 | Bed vibration |
| | 4.9699 | 0.1 | Human body movement and pulsation |
| | 4.96999 | 0.01 | Structure vibration of building and |
| | | | infrastructure |

As shown in Table 1 above, by selecting one from a plurality of signals by the switch 56, vibration characteristics of various target objects 14 having different vibration frequencies can be measured by one laser interferometer 1. Accordingly, the laser interferometer 1 that can be used for various applications can be obtained.

### 5. Fourth Embodiment

Next, a spectroscopic apparatus according to a fourth embodiment will be described.

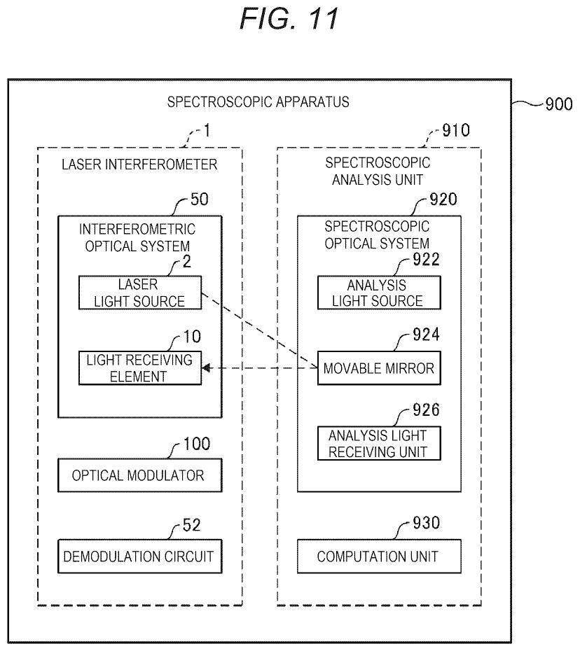

FIG. 11 is a functional block diagram showing a spectroscopic apparatus 900 according to the fourth embodiment.

The fourth embodiment will be described below, and in the following description, differences from the first embodiment will be primarily described, and description of the same items will be omitted. In FIG. 11, the same reference numerals are given to the same configurations as those in FIG. 1.

The spectroscopic apparatus 900 shown in FIG. 11 includes the laser interferometer 1 according to each embodiment described above and a spectrometer 910.

The spectrometer 910 receives analysis light including a sample-derived signal generated through interaction with a sample, and generates spectroscopic spectral information derived from the sample. The spectrometer 910 shown in FIG. 11 includes a spectroscopic optical system 920 and a computation unit 930. The spectroscopic optical system 920 includes an analysis light source 922, a movable mirror 924, and an analysis light receiving unit 926. In the spectroscopic optical system 920, the analysis light emitted from the analysis light source 922 is emitted to the sample and then is incident on an analysis light interferometer. The analysis light interferometer causes interference between the analysis light passing through the sample and the analysis light passing through the movable mirror 924 while changing a light path length by moving the movable mirror 924. Then, interference light is received by the analysis light receiving unit 926, and an analysis light reception signal is acquired.

Meanwhile, the laser interferometer 1 measures a displacement of the movable mirror 924 and outputs a mirror position signal. Since the laser interferometer 1 can accurately measure the displacement of the movable mirror 924, the mirror position signal can be generated with high accuracy.

The computation unit 930 generates a waveform (interferogram) representing an intensity of the interference light with respect to the light path length in the spectroscopic optical system 920 based on the analysis light reception signal and the mirror position signal, performs Fourier transform on the waveform, and generates the spectroscopic spectral information.

Therefore, the spectrometer 910 can generate highly accurate spectroscopic spectral information based on a measurement result of the displacement of the movable mirror 924 measured by the laser interferometer 1.

The laser interferometer 1 can be easily reduced in cost as described above. Therefore, according to the configuration described above, it is possible to obtain the spectroscopic apparatus 900 that is easily reduced in cost and has excellent wavenumber resolution.

By appropriately changing a type of the analysis light or the like, the spectroscopic apparatus 900 can be applied to, for example, Fourier infrared spectroscopy (FT-IR), Fourier near-infrared spectroscopy (FT-NIR), Fourier visible spectroscopy (FT-VIS), Fourier ultraviolet spectroscopy (FT-UV) and Fourier terahertz spectroscopy (FT-THz).

The spectroscopic apparatus 900 can be applied to, for example, a white-light interferometric shape measurement apparatus or an optical coherence tomography (OCT) imaging apparatus by using an element that can acquire a two-dimensional light intensity distribution as the analysis light receiving unit 926.

### 6. Effects Provided by Embodiments Described Above

The optical modulator 100 according to each of the embodiments and the modification is an optical modulator coupled to the demodulation circuit 52 that demodulates, based on the reference signal, the sample signal from the laser light reception signal including the sample signal added to the object light L3 (laser light) by the target object 14 and the modulation signal added to the reference light L2 (laser light), and includes the first resonator 30, the second resonator 31, the optical modulator 12, the first signal oscillator 511, the second signal oscillator 512, and the reference signal generator 54. The first resonator 30 vibrates at the first frequency f_{M}. The second resonator 31 vibrates at the second frequency f_{C} different from the first frequency f_{M}. The optical modulator 12 adds the modulation signal to the incident first split light L1a (laser light) using the first resonator 30. The first signal oscillator 511 generates, using the first resonator 30 as source oscillation, the first signal Ss1 at the first frequency f_{M}. The second signal oscillator 512 generates, using the second resonator 31 as source oscillation, the second signal Ss2 at the second frequency f_{C}. The reference signal generator 54 generates the reference signal SsL at the frequency lower than both the first frequency f_{M} and the second frequency f_{C} using the first signal Ss1 and the second signal Ss2.

According to such a configuration, the frequency of the signal to be subjected to the computational processing in the demodulation circuit 52 can be lowered, and thus the frequency required to be handled by the electronic component and the like used in the demodulation circuit 52 can be lowered. Therefore, by providing the above configuration, it is possible to obtain the optical modulator 100 that can reduce cost of the coupled demodulation circuit 52.

The optical modulator 12 may include the diffraction grating 434 that is provided at the first resonator 30 to diffract the incident first split light L1a (laser light).

According to such a configuration, the frequency of the first split light L1a can be modulated even when the first resonator 30 is, for example, an element that performs thickness-shear vibration. Accordingly, for example, the optical modulator 12 using a quartz crystal AT resonator having a high mechanical resonance Q value can be obtained.

The optical modulator 12 may include the light reflector 406 that is provided at the first resonator 30 to reflect the incident first split light L1a (laser light).

According to such a configuration, when the first split light L1a is reflected, the frequency of the first split light L1a can be modulated to generate the reference light L2.

The first resonator 30 and the second resonator 31 are preferably quartz crystal resonators.

According to such a configuration, since quartz crystal is a piezoelectric material, the first resonator 30 and the second resonator 31 having particularly high frequency stability are obtained.

The first frequency f_{M} and the second frequency f_{C} are preferably 1 MHz or higher and 100 MHz or lower.

In a frequency band within this range, there are a large number of resonators having a high mechanical resonance Q value. Therefore, by setting the first frequency f_{M} and the second frequency f_{C} within this range, the first frequency f_{M} of the first signal Ss1 output from the first signal oscillator 511 and the second frequency f_{C} of the second signal Ss2 output from the second signal oscillator 512 can be stabilized.

The optical modulator 100 according to each of the embodiments and the modification includes the third resonator 31A, the third signal oscillator 512A, and the switch 56. The third resonator 31A vibrates at the third frequency different from the first frequency f_{M} and the second frequency f_{C}. The third signal oscillator 512A generates, using the third resonator 31A as source oscillation, the third signal Ss3 at the third frequency. The switch 56 selects the second signal Ss2 or the third signal Ss3 and inputs the selected signal to the reference signal generator 54. Then, the reference signal generator 54 generates, using the first signal Ss1 and the signal selected in the switch 56 (selection signal SsX), the reference signal SsL at a frequency lower than both the first frequency f_{M} and a frequency of the selection signal SsX.

According to such a configuration, the frequency f′_{M} after the down-conversion in the reference signal generator 54 can be switched. Accordingly, the optimum frequency f′_{M} can be selected according to the vibration characteristic of the target object 14. As a result, it is possible to obtain the laser interferometer 1 that can acquire optimum measurement data according to the vibration characteristic of the target object 14.

The laser interferometer 1 according to each of the embodiments and the modification includes the laser light source 2, the optical modulator 100 according to each of the embodiments and the modification, the photodetector 10, and the demodulation circuit 52. The laser light source 2 emits the emission light L1 (laser light). The optical modulator 100 adds the modulation signal to the first split light L1a (laser light). The photodetector 10 detects a change in an intensity of the interference light (laser light) including the sample signal and the modulation signal, and outputs the laser light reception signal. The demodulation circuit 52 is coupled to the optical modulator 100 to demodulate the sample signal from the laser light reception signal based on the reference signal SsL.

According to such a configuration, cost of the laser interferometer 1 can be easily reduced.

The spectroscopic apparatus 900 according to the embodiment includes the laser interferometer 1 according to each of the embodiments and the modification and the spectrometer 910. The spectrometer 910 includes the spectroscopic optical system 920 including the movable mirror 924, and generates the spectroscopic spectral information derived from the sample. The laser interferometer 1 measures the displacement of the movable mirror 924. The spectrometer 910 generates the spectroscopic spectral information based on the measurement result of the displacement of the movable mirror 924 measured by the laser interferometer 1.

According to such a configuration, cost of the spectroscopic apparatus 900 can be easily reduced.

Although the optical modulator, the laser interferometer, and the spectroscopic apparatus according to the disclosure have been described above based on the shown embodiments, the optical modulator, the laser interferometer, and the spectroscopic apparatus according to the disclosure are not limited to the embodiments and modification, and the configuration of each unit may be replaced with any component or any other component may be added.

A Michelson interferometric optical system is used in the embodiments and modification, and alternatively, an interferometric optical system of another type may be used.

What is claimed is:

1. An optical modulator coupled to a demodulation circuit for demodulating, from a laser light reception signal including a sample signal added to laser light by a target object and a modulation signal added to the laser light, the sample signal based on a reference signal, the optical modulator comprising:
a first resonator configured to vibrate at a first frequency;
a second resonator configured to vibrate at a second frequency different from the first frequency;
an optical modulator configured to add, using the first resonator, the modulation signal to incident laser light;
a first signal oscillator configured to generate, using the first resonator as source oscillation, a first signal having the first frequency;
a second signal oscillator configured to generate, using the second resonator as source oscillation, a second signal having the second frequency; and
a reference signal generator configured to generate, using the first signal and the second signal, the reference signal having a frequency lower than both the first frequency and the second frequency.

2. The optical modulator according to claim 1, wherein
the optical modulator includes a diffraction grating that is provided at the first resonator to diffract the incident laser light.

3. The optical modulator according to claim 1, wherein
the optical modulator includes a light reflector that is provided at the first resonator to reflect the incident laser light.

4. The optical modulator according to claim 1, wherein
the first resonator and the second resonator are quartz crystal resonators.

5. The optical modulator according to claim 1, wherein
the first frequency and the second frequency are 1 MHz or higher and 100 MHz or lower.

6. The optical modulator according to claim 1, further comprising:
a third resonator configured to vibrate at a third frequency different from the first frequency and the second frequency;
a third signal oscillator configured to generate, using the third resonator as source oscillation, a third signal having the third frequency; and
a switch configured to select the second signal or the third signal and input the selected signal to the reference signal generator, wherein
the reference signal generator generates, using the first signal and the signal selected by the switch, the reference signal having a frequency lower than both the first frequency and a frequency of the selected signal.

7. A laser interferometer comprising:
a laser light source configured to emit laser light;
the optical modulator according to claim 1 configured to add the modulation signal to the laser light;
a photodetector configured to detect a change in an intensity of the laser light including the sample signal and the modulation signal, and to output the laser light reception signal; and
the demodulation circuit coupled to the optical modulator and configured to demodulate the sample signal from the laser light reception signal based on the reference signal.

8. A spectroscopic apparatus comprising:
the laser interferometer according to claim 7; and
a spectrometer including a spectroscopic optical system that includes a movable mirror and configured to generate spectroscopic spectral information derived from a sample, wherein
the laser interferometer measures a displacement of the movable mirror, and
the spectrometer generates the spectroscopic spectral information based on a measurement result of the displacement of the movable mirror measured by the laser interferometer.
